(19) United States
(12) Patent Application Publication
(10) Pub. No.: US 2011/0200350 A1
(43) Pub. Date: Aug. 18, 2011

(54) PROCESS UNIT FOR AN IMAGE-FORMING DEVICE

(75) Inventor: Kiyomitsu KUMAZAWA, Nagoya-shi (JP)

(73) Assignee: BROTHER KOGYO KABUSHIKI KAISHA, Nagoya-shi (JP)

(21) Appl. No.: 13/016,825

(22) Filed: Jan. 28, 2011

(30) Foreign Application Priority Data
Feb. 3, 2010 (JP) 2010-022475

(51) Int. Cl. G03G 21/20

(52) U.S. Cl. 399/92

(57) ABSTRACT

A process unit includes a photosensitive drum, a frame, a partitioning member, and a charging wire. The photosensitive drum has a rotational axis extending in an axis direction. A space is formed in the frame. The partitioning member is disposed in the space to partition the space into a first air passage into which an air flows from an outside of the frame and a second air passage. The separating member is formed with a ventilation hole thorough which the air flows into the second air passage from the first air passage. The charging wire is disposed in the second air passage and extends in the axis direction to charge the photosensitive drum. The frame is formed with a guiding surface that guides the air flowing into the second air passage toward the charging wire.

### CROSS REFERENCE TO RELATED APPLICATION

This application claims priority from Japanese Patent Application No. 2010-022475 filed Feb. 3, 2010. The entire content of this application is incorporated herein by reference.

### TECHNICAL FIELD

The present invention relates to a process unit provided in an image-forming device.

### BACKGROUND

Tandem-type electrophotographic color printers are well known in the art. A tandem-type color printer has four photosensitive drums for the colors yellow, magenta, cyan, and black, for example, the drums being disposed parallel to one another in a tandem arrangement.

This tandem color printer is also provided with a Scorotron charger and a developer cartridge for each photosensitive drum.

Each Scorotron charger is positioned on one side of the corresponding photosensitive drum with respect to the direction in which the drums are aligned. As shown in FIG. 7, a Scorotron charger includes a charging wire (discharge wire) 101, and a frame 102. The frame 102 accommodates a wire cleaner (not shown) for cleaning the charging wire 101. The side of the frame 102 opposite a photosensitive drum 103 is open, and a cover part 104 is attached to the frame 102 for covering the open side surface thereof. The cover part 104 has a flat plate shape and can open and close on the frame 102. A partitioning piece 105 is disposed on the inner side of the cover part 104.

When the cover part 104 is in a closed state, the partitioning piece 105 divides the interior space of the Scorotron charger into a charging space 106 in which the charging wire 101 and the wire cleaner are disposed, and a ventilating space 107 for supplying air to the charging wire 101. By supplying air from the ventilating space 107 to the charging wire 101 (i.e., into the charging space 106), the Scorotron charger can minimize the amount of foreign matter deposited on the charging wire 101.

### SUMMARY

However, while the above structure for a Scorotron charger proposed in the prior art supplies airflow from the ventilating space 107 into the charging space 106, the structure gives no consideration for conducting the air toward the charging wire 101. In fact, air introduced into the charging space 106 flows along the inner surface of the plate-shaped cover part 104 and is conducted to a position away from the charging wire 101. Accordingly, this structure may not be able to minimize the amount of foreign matter deposited on the charging wire 101.

It is an object of the present invention to provide a process unit capable of effectively minimizing the amount of foreign matter deposited on a charging wire.

In view of the foregoing, it is an object of the invention to provide a process unit including a photosensitive drum, a frame, a partitioning member, and a charging wire. The photosensitive drum has a rotational axis extending in an axis direction. A space is formed in the frame. The partitioning member is disposed in the space to partition the space into a first air passage into which an air flows from an outside of the frame and a second air passage. The separating member is formed with a ventilation hole thorough which the air flows into the second air passage from the first air passage. The charging wire is disposed in the second air passage and extends in the axis direction to charge the photosensitive drum. The frame is formed with a guiding surface that guides the air flowing into the second air passage toward the charging wire.

### BRIEF DESCRIPTION OF THE DRAWINGS

The particular features and advantages of the invention as well as other objects will become apparent from the following description taken in connection with the accompanying drawings, in which:

FIG. 1 shows a color printer according to a first embodiment;

FIG. 2 is a perspective view of a drum unit shown in FIG. 1 when viewing the drum unit from a left-rear-upper of the drum unit;

FIG. 3 is a side view of a front part of a right side plate shown in FIG. 2;

FIG. 4 is a side view of a Scorotron charger and a photosensitive drum;

FIG. 5 is a perspective view of a cover member;

FIG. 6 is a side view of a Scorotron charger and a photosensitive drum according to a second embodiment; and

FIG. 7 is a side view of a conventional Scorotron charger.

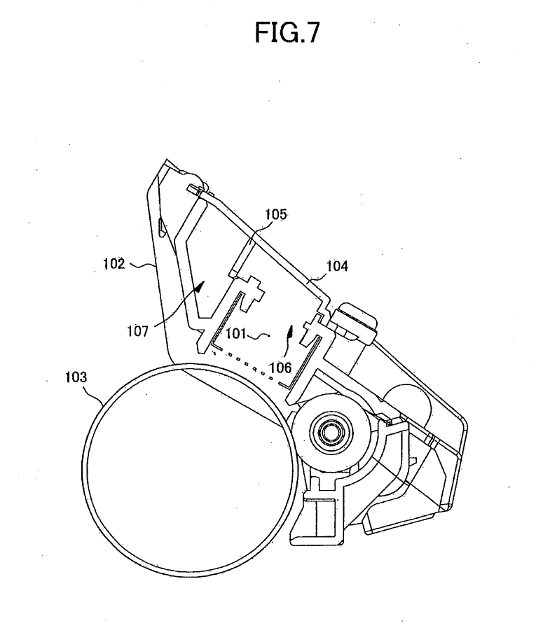

### DETAILED DESCRIPTION

Next, a preferred embodiment of the present invention will be described while referring to the accompanying drawings.

### 1. Overall Structure of a Color Printer

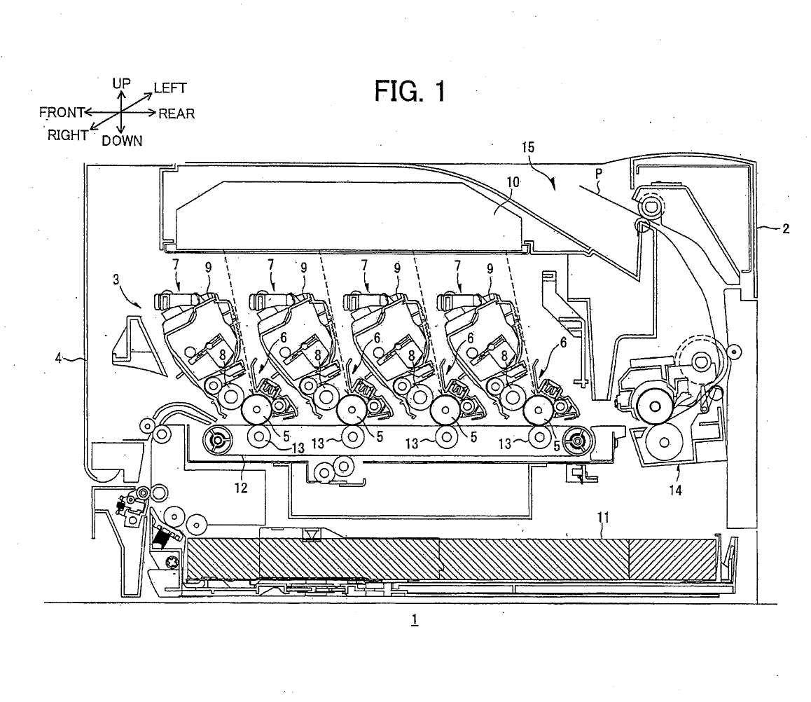

As shown in FIG. 1, a tandem-type color printer 1 includes a main casing 2. A drum unit (a process unit) 3 according to a first embodiment is mounted in the main casing 2. A front cover 4 is disposed on one side wall of the main casing 2. By opening the front cover 4, the drum unit 3 can be mounted in and removed from the main casing 2.

In the following description, the side of the main casing 2 on which the front cover 4 is provided (the left side in FIG. 1) will be called the “front side,” and the opposite side (the right side in FIG. 1) will be called the “rear side.” Further, the left and right sides of the main casing 2 will be based on the perspective of a user looking at the printer 1 from the front side.

Four photosensitive drums 5 are disposed in the drum unit 3. The photosensitive drums 5 are provided respectively for colors black, yellow, magenta, and cyan. The four photosensitive drums 5 are arranged parallel to each other and juxtaposed in the front-to-rear direction in the order black, yellow, magenta, and cyan.

Scorotron chargers 6 and developer cartridges 7 are also provided in the drum unit 3, with one Scorotron charger 6 and one developer cartridge 7 corresponding to each photosensitive drum 5. Each developer cartridge 7 includes a developing roller 8 that supplies toner to the corresponding photosensitive drum 5, and a box-shaped developer frame 9 for accommodating toner. The developing roller 8 is held in the developer frame 9 so that the peripheral surface of the developing roller 8 is exposed in the lower end of the developer frame 9. The developer cartridges 7 are detachably mounted in the drum unit 3.

An exposure unit 10 is provided above the drum unit 3. The exposure unit 10 irradiates four laser beams based on prescribed image data for each color over surfaces of the corresponding photosensitive drums 5.

As the photosensitive drum 5 rotates, the corresponding Scorotron charger 6 applies a uniform charge to the surface of the photosensitive drum 5 through corona discharge. Subsequently, the exposure unit 10 irradiates a laser beam for selectively exposing the surface of the photosensitive drum 5. This laser beam exposure selectively removes charge form the surface of the photosensitive drum 5, forming an electrostatic latent image thereon. As the latent image rotates to a position opposite the corresponding developing roller 8, the developing roller 8 supplies toner to the latent image, forming a toner image on the surface of the photosensitive drum 5.

Here, four LED arrays may be provided, one for each photosensitive drum 5, in place of the exposure unit 10.

A paper cassette 11 for accommodating sheets of a paper P is disposed in the bottom section of the main casing 2. The paper P accommodated in the paper cassette 11 is conveyed onto a conveying belt 12 by various rollers. The conveying belt 12 is arranged so that its top surface confronts the bottom peripheral surfaces of the four photosensitive drums 5. Four transfer rollers 13 are disposed inside the conveying belt 12 at positions confronting each of the photosensitive drums 5 through the upper portion of the conveying belt 12. Once a sheet of paper P is conveyed onto the conveying belt 12, the conveying belt 12 carries the sheet sequentially through positions between the conveying belt 12 and each of the photosensitive drums 5. At this time, a transfer bias applied to each transfer roller 13 transfers the toner image carried on the respective photosensitive drum 5 to the sheet of paper P as the toner image rotates opposite the paper P.

A fixing unit 14 is disposed on the downstream end of the conveying belt 12 with respect to the direction that the paper P is conveyed. After toner images are transferred onto the paper P, the paper P is conveyed to the fixing unit 14, where the toner images are fixed to the sheet by heat and pressure. After the toner images are fixed in the fixing unit 14, various rollers discharge the sheet onto a discharge tray 15 formed on the top surface of the main casing 2.

### 2. Drum Unit

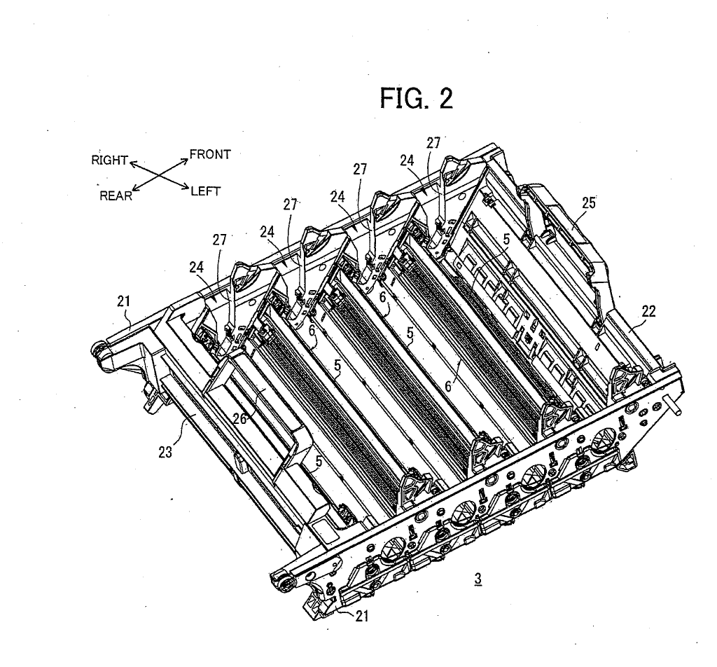

As shown in FIG. 2, the drum unit 3 includes a pair of side plates 21 arranged parallel to each other and separated in the left-to-right direction, a front beam 22 bridging the front end parts of the side plates 21, and a rear beam 23 bridging the rear ends parts of the side plates 21.

The four photosensitive drums 5 are disposed in parallel and at regular intervals in the front-to-rear direction between the front beam 22 and rear beam 23. The axial ends of each photosensitive drum 5 are rotatably held in the side plates 21.

The Scorotron chargers 6 are disposed on the rear sides of the corresponding photosensitive drums 5 and are tightly held between the side plates 21.

A mounting position 24 is established on the front side of each photosensitive drum 5. The mounting positions 24 indicate positions at which the respective developer cartridges 7 (see FIG. 1) are detachably mounted in the drum unit 3.

The front beam 22 is formed of a synthetic resin material. A front-side handle 25 is integrally formed on the front beam 22 at a position in the left-to-right center of the same. The front-side handle 25 has a U-shape in a front view, with both ends of the front-side handle 25 coupled to the front beam 22. The front-side handle 25 protrudes upward from the front beam 22.

The rear beam 23 is also formed of a synthetic resin material. A rear-side handle 26 is integrally formed on the rear beam 23 at a position in the left-to-right center of the same. The rear-side handle 26 has a U-shape in a rear view, with both ends of the rear-side handle 26 coupled to the rear beam 23. The rear-side handle 26 protrudes upward from the rear beam 23 with a forward slope from bottom to top.

When the front cover 4 (see FIG. 1) is in an open state, an operator can grip the front-side handle 25 and slide the drum unit 3 in the front and rear directions relative to the main casing 2. Once the drum unit 3 has been pulled outward from the main casing 2 to the extent that the rear-side handle 26 is positioned at the front edge of the main casing 2, the operator can grip both handles 25 and 26 and remove the drum unit 3 from the main casing 2.

Four cartridge guiding parts 27 are formed in the inner surfaces of each of the left and right side plates 21 (i.e., the right surface of the left side plate 21 and the left surface of the right side plate 21) at regular intervals in the front-to-rear direction. The cartridge guiding parts 27 function to guide the corresponding developer cartridges 7 relative to the side plates 21 as the developer cartridges 7 are mounted in and removed from the side plates 21. Each cartridge guiding part 27 is formed as a recess in the inner surface of the respective side plate 21. The cartridge guiding parts 27 slope at a fixed inclination from the top edge of the side plate 21 toward the bottom rear, with the lower ends approaching respective photosensitive drums 5. Each pair of left and right cartridge guiding parts 27 face the corresponding mounting position 24 at which one of the developer cartridges 7 is mounted.

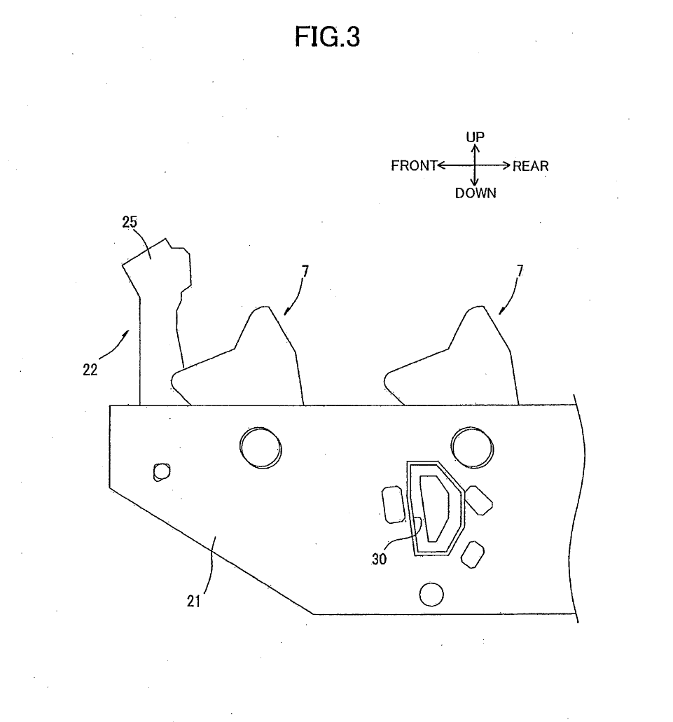

Four substantially square-shaped air holes 30 are formed in the right side plate 21 and penetrate the side plate 21 in the left-to-right direction (only one air hole 30 is shown in FIG. 3), although only one air hole is shown in FIG. 3. The air holes 30 are formed at positions opposing the Scorotron chargers 6 (see FIG. 2), respectively, with respect to the left-to-right direction. The air holes 30 provide communication between the interior of the Scorotron chargers 6 and the exterior (right side) of the right side plate 21. Therefore, air outside the side plate 21 is supplied into the Scorotron chargers 6 via the air holes 30.

### 3. Scorotron Charger

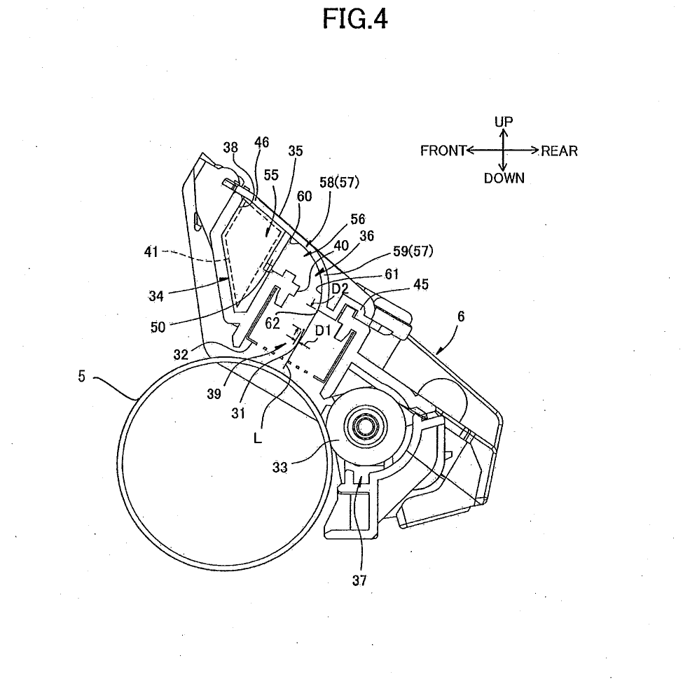

As shown in FIG. 4, each Scorotron charger 6 includes a charging wire 31; a charging grid 32; a paper dust roller 33; a charger frame 34 for holding the charging wire 31, charging grid 32, and paper dust roller 33; and a cover member 35 mounted on the charger frame 34. The charging wire 31 extends in a direction in which the shaft (axis) of the photosensitive drum 5 extends, to charge the surface of the photosensitive drum 5.

The charger frame 34 is elongated in the left-to-right direction, with both left and right ends fixed to the inner surfaces of the left and right side plates 21 (see FIG. 2). An upper space 36 and a lower space 37 are provided in the interior of the charger frame 34. The lower space 37 is disposed adjacent to the bottom side of the upper space 36 and rearward of the photosensitive drum 5.

The upper space 36 opens out from the charger frame 34 in a diagonal direction upward and rearward. That is to say, an opening 38 is formed in the upper rear side of the charger frame 34, and the upper space 36 is in communication with the opening 38.

The bottom portion of the upper space 36 forms a charging space 39. The charging wire 31 and charging grid 32 are disposed in the charging space 39. The charging space 39 is defined by the charger frame 34 and opens outward from the charger frame 34 in both a direction diagonally downward and forward and a direction diagonally upward and rearward. The charging space 39 communicates with the lower portion of the upper space 36 via a frame opening 40 that penetrates the charger frame 34 in a direction that is substantially vertical.

The lower space 37 opens out from the charger frame 34 in a forward direction. The paper dust roller 33 is disposed in the lower space 37. The peripheral surface of the paper dust roller 33 contacts the peripheral surface of the photosensitive drum 5 on the rear side thereof. The lower space 37 recovers deposited foreign matter, such as paper dust, from the surface of the photosensitive drum 5 when the foreign matter is brought against the surface of the lower space 37 through the rotation of the photosensitive drum 5.

A substantially quadrilateral air supply hole 41 indicated by the dotted line in FIG. 4 is formed in the right side surface of the charger frame 34. The air supply hole 41 penetrates the charger frame 34 in the left-to-right direction at a position opposing a first air passage 55 described later in the left-to-right direction. The air supply hole 41 opposes the air hole 30 (see FIG. 3) formed in the right side plate 21 in the left-to-right direction. Accordingly, air outside the side plate 21 passes through the air hole 30 and air supply hole 41 into the upper space 36 and flows toward the left end of the upper space 36 (the first air passage 55).

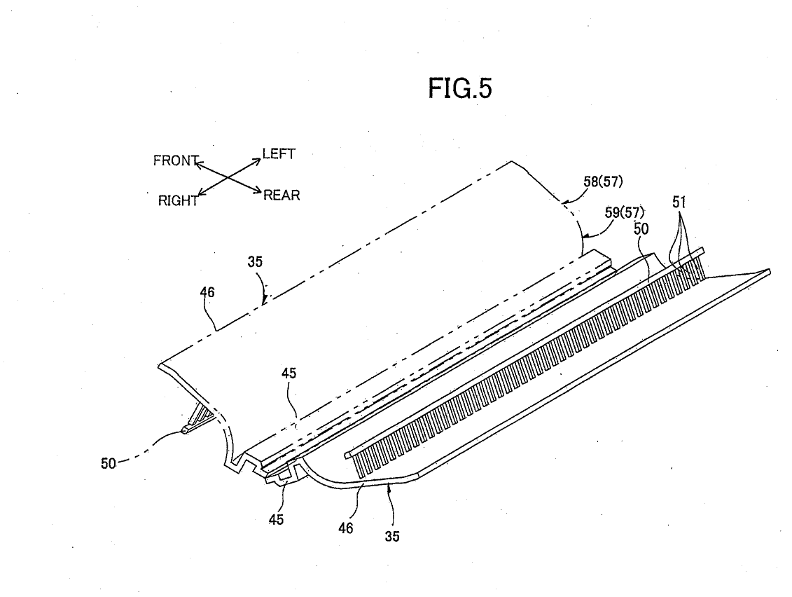

The cover member 35 has a plate shape with a width in the left-to-right direction substantially equivalent to the width of the charger frame 34. FIG. 5 is a perspective view of the cover member 35 positioned at an open position in which the upper space 36 is exposed and a closed position in which the upper space 36 is closed. As shown in FIG. 5, the cover member 35 is integrally provided with a support part 45, and an engaging part 46. The support part 45 has a squared U-shape in a side view, with the opening portion of the U-shape facing diagonally downward and forward when the cover member 35 is mounted on the charger frame 34. The engaging part 46 extends continuously from the support part 45 in a direction diagonally upward and forward.

A part of the charger frame 34 forming the periphery of the frame opening 40 is inserted into the support part 45. Through this insertion, the cover member 35 is mounted and supported on the charger frame 34. By pivoting the cover member 35 about the support part 45, the cover member 35 can be displaced between the open position and the closed position.

The engaging part 46 is formed large enough to completely cover the opening 38 in the charger frame 34. A flow-regulating plate 50 elongated in the left-to-right direction is provided on the inner surface of the engaging part 46 (the surface facing the upper space 36 when the cover member 35 is attached to the charger frame 34).

The flow-regulating plate 50 protrudes from the inner surface of the engaging part 46 in a direction substantially orthogonal to the engaging, part 46. The flow-regulating plate 50 has the shape of a substantially rectangular plate with a width in the left-to-right direction approximately equal to the width of the cover member 35. Ventilation holes 51 are formed in the flow-regulating plate 50 at regular intervals along the left-to-right direction. The ventilation holes 51 are rectangular in shape and elongated in the protruding direction of the flow-regulating plate 50. The ventilation holes 51 give the flow-regulating plate 50 a comb-like structure, whereby the distal edge of the flow-regulating plate 50 extending orthogonally outward from the engaging part 46 is closed.

As shown in FIG. 4, the flow-regulating plate 50 is positioned inside the upper space 36 when the cover member 35 is mounted on the charger frame 34. In this state, the flow-regulating plate 50 partitions the upper space 36 into the first air passage 55 opposing the air supply hole 41 (see FIG. 4) in the left-to-right direction, and a second air passage 56 diagonally adjacent to the first air passage 55 on the lower rear side thereof.

The portion of the engaging part 46 opposing the second air passage 56 constitutes a guiding part 57. The guiding part 57 curves toward the charging wire 31 near the support part 45 side. More specifically, the guiding part 57 is integrally provided with a flat part 58 having a flat inner surface 60, and a curved part 59 formed continuously with the flat part 58 and having a curved inner surface 61.

The flat inner surface 60 is substantially orthogonal to the flow-regulating plate 50.

The curved inner surface 61 is formed continuously with the flat inner surface 60 in an arc shape. The outer curve of the are shape faces away from the charger frame 34. The curved inner surface 61 has a radius of curvature no less than 4 mm and no greater than 20 mm. The curved inner surface 61 has an end 62 at an opposite end of the end formed continuously with the flat inner surface 60 (hereinafter referred to simply as the “downstream end 62”). The air flowing into the second air passage 56 is launched toward the charging wire 31 from the downstream end 62. The curved inner surface 61 is also curved so that a tangent L to the down stream end 62 passes near the charging wire 31.

A linear distance D1 between the charging wire 31 and the tangent L to the curved inner surface 61 at the downstream end 62 is within 5 mm, for example. Further, a linear distance D2 between the charging wire 31 and the downstream end 62 of the curved inner surface 61, that is, a distance between the charging wire 31 and a plane orthogonal to the tangent L and passing through the downstream end 2, is within 10 mm, and preferably within 8 mm, for example.

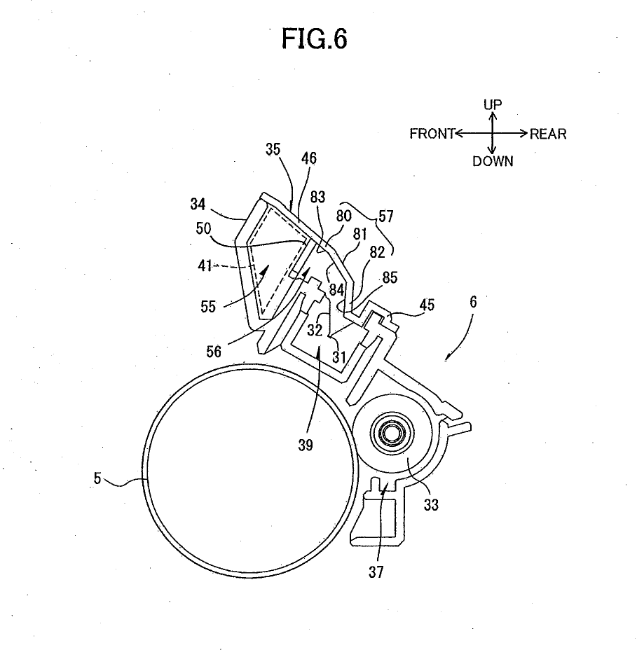

With this configuration, air outside the side plate 21 (see FIG. 3) passes through the air hole 30 and air supply hole 41 into the first air passage 55 of the upper space 36 and flows from right to left within the first air passage 55. The air flowing within the first air passage 55 subsequently flows into the second air passage 56 through the ventilation holes 51 formed in the flow-regulating plate 50 (see FIG. 6).

Air flowing into the second air passage 56 is guided in a direction along the flat inner surface 60 and curved inner surface 61 of the guiding part 57 so as to flow into the charging space 39 where the charging wire 31 is accommodated.

### 4. Operations and Effects

As described above, the charging wire 31 is disposed in the charger frame 34. Further, the first and second air passages 55 and 56 are formed in the charger frame 34. The first air passage 55 extends in the left-to-right direction, and the second air passage 56 is in communication with the first air passage 55. Hence, air flowing into the first air passage 55 is supplied into the second air passage 56 and flows through the second air passage 56 toward the charging space 39.

The guiding part 57 formed on the charger frame 34 (the engaging part 46) at a position facing the second air passage 56 extends toward the charging wire 31. Accordingly, air flowing in the second air passage 56 toward the charging space 39 is guided by the guiding part 57 to flow in a direction toward the charging wire 31. Thus, this construction can efficiently supply air to the charging wire 31 and can minimize the amount of foreign matter deposited on the charging wire 31.

Further, the curved inner surface 61 constitutes the downstream end 62 of the guiding part 57 with respect to the direction of airflow in the second air passage 56. Therefore, air guided along the curved inner surface 61 can be smoothly supplied to the charging wire 31 without the flow of air becoming stagnant.

Further, the curved inner surface 61 curves such that the tangent L to the curved inner surface 61 at the downstream end 62 passes near the charging wire 31. The curved inner surface 61 has a radius of curvature no less than 4 mm and no greater than 20 mm. Accordingly, air guided along the guiding part 57 can be supplied to the charging wire 31 more efficiently.

Further, the linear distance D1 between the charging wire 31 and the tangent L is within 5 mm, and the linear distance D2 between the charging wire 31 and the downstream end 62 of the guiding part 57 relative to the direction of airflow is within 10 mm. Accordingly, air guided along the guiding part 57 can be supplied to the charging wire 31 more efficiently.

### 5. Second Embodiment

As shown in FIG. 6, in a second embodiment of the present invention, the guiding part 57 of the cover member 35 has a plurality of flat parts 80, 81, and 82 (specifically, a first flat part 80, a second flat part 81, and a third flat part 82 in the preferred embodiment).

A first flat surface 83 is formed on the inner surface of the first flat part 80. The first flat surface 83 extends from the point at which the flow-regulating plate 50 connects to the cover member 35 in a direction substantially orthogonal to the flow-regulating plate 50.

A second flat surface 84 is formed on the inner surface of the second flat part 81. The second flat surface 84 is formed continuously from the downstream end of the first flat surface 83 with respect to the direction of airflow (hereinafter simply referred to as the “downstream end”) and extends in a direction advancing closer toward the charging wire 31 than the extended direction of the first flat surface 83.

A third flat surface 85 is formed on the inner surface of the third flat part 82. The third flat surface 85 is formed continuously from the downstream end of the second flat surface 84 and extends in a direction that advances even closer toward the charging wire 31 than the second flat surface 84. Further, an extension to the extended direction of the third flat surface 85 in a side view passes near the charging wire 31. Thus, the air flowing into the second air passage 56 is launched toward the charging wire 31.

Hence, the interconnected flat surfaces 83, 84, and 85 describe a pseudo are overall. Accordingly, air flowing through the second air passage 56 is guided along the first flat surface 83, second flat surface 84, and third flat surface 85 of the guiding part 57, which gradually change the direction of flow so that the air is introduced into the charging space 39 where the charging wire 31 is accommodated.

As described above, the guiding part 57 includes the flat parts 80, 81, and 82. Since the third flat part 82 extends toward the charging wire 31, air flowing through the second air passage 56 is guided along the flat surfaces 83, 84, and 85 and supplied to the charging wire 31. Therefore, this construction can efficiently supply air to the charging wire 31 and can minimize the amount of foreign matter deposited on the charging wire 31.

Further, the third flat surface 85 is formed such that an extension to the third flat surface 85 in a side view passes near the charging wire 31. Accordingly, air guided along the third flat surface 85 can be supplied to the charging wire 31 more efficiently.

### 6. Variations of the Embodiment

While the invention has been described in detail with reference to two embodiments thereof, it would be apparent to those skilled in the art that many modifications and variations may be made therein without departing from the spirit of the invention, the scope of which is defined by the attached claims.

For example, in the second embodiment described above, the guiding part 57 is configured of three flat parts 80, 81, and 82. However, the guiding part 57 may be configured of two flat parts, or four or more flat parts, provided that the flat part disposed on the downstream end with respect to the direction of airflow leads toward the charging wire 31.

The cover member 35 may be formed of the same material as the charger frame 34 (a synthetic resin material, for example) or may be formed of a rubber material having elasticity.

The flow-regulating plate 50 may alternatively be fixed relative to the charger frame 34.

A cleaning member for cleaning the charging wire 31 may also be provided in the Scorotron charger 6. For example, a cleaning member capable of sliding in the left and right directions may be provided in the frame opening 40. The user can remove foreign matter deposited on the surface of the charging wire 31 by sliding the cleaning member after detaching the cover member 35 from the charger frame 34.

What is claimed is:

1. A process unit comprising:
a photosensitive drum having a rotational axis extending in an axis direction;
a frame in which a space is formed;
a partitioning member disposed in the space to partition the space into a first air passage into which an air flows from an outside of the frame and a second air passage, the separating member being formed with a ventilation hole thorough which the air flows into the second air passage from the first air passage; and
a charging wire disposed in the second air passage and extending in the axis direction to charge the photosensitive drum,
wherein the frame is formed with a guiding surface that guides the air flowing into the second air passage toward the charging wire.

2. The process unit according to claim 1, wherein the guiding surface has a curved surface to guide the air flowing into the second air passage toward the charging wire.

3. The process unit according to claim 2, wherein the curved surface has an end part from which the air flowing into the second air passage is launched toward the charging wire, a tangent to the curved surface at the end part passing thorough around the charging wire.

4. The process unit according to claim 3, wherein a distance between the charging wire and the tangent is within 5 mm.

5. The process unit according to claim 3, wherein a distance between the charging wire and a plane orthogonal to the tangent and passing thorough the end part is within 10 mm.

6. The process unit according to claim 2, wherein the curved surface has a radius of curvature no less than 4 mm and no greater than 20 mm.

7. The process unit according to claim 1, wherein the guiding surface has a plurality of flat surfaces sequentially connected, an end flat surface among the plurality of flat parts from which the air flowing into the second air passage is launched toward the charging wire extending toward the charging wire.

8. The process unit according to claim 1, wherein an extension of the end flat surface passes thorough around the charging wire.
